(19) United States
(12) Patent Application Publication
(10) Pub. No.: US 2025/0236061 A1
(43) Pub. Date: Jul. 24, 2025

(54) METHOD FOR MANUFACTURING A BLADE FOR A SUSPENSION

(71) Applicant: JTEKT EUROPE, IRIGNY (FR)

(72) Inventors: Jean-Noël PAQUIEN, Mions (FR); Michel Kamga Nguemdjom, Villeurbanne (FR)

(73) Assignee: JTEKT EUROPE, IRIGNY (FR)

(21) Appl. No.: 19/027,393

(22) Filed: Jan. 17, 2025

(30) Foreign Application Priority Data
Jan. 18, 2024 (FR) 24/00503

(51) Int. Cl. B29C 51/02; B29C 51/00; B29C 51/26; B29K 105/10; B29L 31/00; B29L 31/30

(52) U.S. Cl. CPC B29C 51/02; B29C 51/002; B29C 51/264; B29K 2105/105; B29L 2031/30; B29L 2031/774

(57) ABSTRACT

A method for manufacturing a blade for a vehicle suspension, the blade having a curved profile in a rest state and being made of a thermoplastic material, the method implementing: a winding step in which an intermediate element is made by continuously winding a thermoplastic strip around a support; a heating step in which the intermediate element is positioned and then heated in a heating device; a placement step in which the heated intermediate element is placed in a shaping mold; a thermoforming step in which a second part of the shaping mold is closed on a first part so as to obtain the blade.

### TECHNICAL FIELD

The invention concerns the field of vehicle suspensions, in particular that of cycle suspensions, and more particularly to a method for manufacturing a blade for a suspension and a blade obtained by said manufacturing method.

### STATE OF THE PRIOR ART

The purpose of a vehicle suspension is to reduce the impact of deformations of a surface on which the vehicle rolls in terms of wear and comfort.

There is a suspension system described in document FR3 037 865 comprising an elastic blade having a rest state in which the blade has a curved profile and a maximum extension state in which the blade has a long, elongated profile. The elastic blade is made using a fiber-based composite, said fibers being continuously wound around metal inserts.

There is therefore a need for a manufacturing method for said blade that is rapid, inexpensive and allows the blade to be recycled.

### DISCLOSURE OF THE INVENTION

An embodiment concerns a method for manufacturing a blade for a vehicle suspension, said blade extending along an elongation axis between a first end and a second end, said blade being elastically deformable between a rest state in which the blade has a curved profile along the elongation axis, and an extension state in which the first and second ends are spaced apart from each other relative to the rest state, said blade being made of a thermoplastic material, said method implementing:
A winding step in which an intermediate element is produced by continuously winding a thermoplastic strip around a support such that the intermediate element has a closed contour delimiting at least one internal space, said strip being wound in an elongation direction of the strip;
A heating step in which the intermediate element is positioned and then heated in a heating device;
A placing step in which the heated intermediate element is placed in a first part of a shaping mold such that a first extreme point and a second extreme point of the intermediate element, taken along an elongation axis of the intermediate element, are spaced from each other by a distance equal to that separating the first and second ends of the blade in the rest state;
A thermoforming step in which a second part of the shaping mold is closed over the first part to obtain the blade.

The blade according to the invention is configured to be assembled in a vehicle suspension, for example a cycle. For this, the blade comprises at least one first fixing point positioned at the first end and a second fixing point positioned at the second end.

The blade is elastically deformable between the rest state and the extended state. Thus, during a compression of the suspension, the blade is stressed in stretching between two points of the suspension which are fixed to the two fixing points, the two points of the suspension moving away from each other.

The blade is formed by a single-piece element which has a bending rigidity, that is to say when the ends of the blade are stretched, much lower than its tensile rigidity, that is to say along its elongation axis.

Furthermore, the blade has a non-zero radius of curvature in the rest state. Said radius of curvature may be constant, variable along the elongation axis, multiple that is to say the blade has an undulating shape, or have secondary profiles, that is to say small undulations that draw a larger undulation.

The blade is made of a thermoplastic material, that is to say a material that has the property of softening when heated but which, when cooled, becomes hard again while retaining the shape obtained when it was hot. The thermoplastic material is recyclable.

In some embodiments, the thermoplastic material is a polymer.

The method comprises a winding step. During this step, the thermoplastic strip is wound in its elongation direction and continuously on a support. The support has a shape identical to a shape of the intermediate element obtained by the winding.

In some embodiments, the intermediate element extends along an elongation axis corresponding to a winding direction of the strip, that is to say the elongation direction of the strip.

In some embodiments, the elongation axis of the intermediate element corresponds to the elongation axis of the blade.

The intermediate element has a closed contour which delimits at least one internal space.

In some embodiments, the intermediate element has a convex shape along a section in a plane in which the elongation axis of the intermediate element extends.

In some embodiments, the intermediate element has a single internal space.

The intermediate element comprises a first extreme point and a second extreme point positioned at each of the ends of the intermediate element taken along its elongation axis.

During the heating step, the intermediate element is softened so that it can be deformed. The intermediate element is heated by a heating device such as an oven or a heating tunnel for example.

The placing step involves moving the hot intermediate element and placing it in the first part of the shaping mold. In this mold, the intermediate element is positioned so that the distance between the first extreme point and the second extreme point is equal to the distance between the first end and the second end of the finally produced blade. In other words, the first extreme point and the second extreme point are fixed relative to the first part of the mold during the thermoforming step.

The thermoforming step consists of closing the second part of the mold on the first part which comprises the intermediate element so as to deform the intermediate element and obtain the desired blade.

Thus, the manufacturing method allows, inexpensively, a significant production volume of recyclable blade.

The object of this disclosure may also exhibit one or more of the following characteristics, taken alone or in combination.

In some embodiments, the thermoplastic strip comprises fibers extending in the elongation direction of the strip.

In some embodiments, the fibers are continuous fibers.

The strip is therefore a composite thermoplastic strip. The fibers are continuous fibers different from short or long fibers which are discontinuous.

The fibers extend in the elongation direction of the strip so that when the strip is wound on the support, the fibers are not interrupted. Thus, the method retains mechanical strength properties of the fibers which are preferably continuous.

In some embodiments, during the winding step, the thermoplastic strip is wound upon itself in at least two layers.

In some embodiments, the thermoplastic strip is wound upon itself in a plurality of layers, for example between 5 and 50 layers.

Thus, it is possible to obtain a desired thickness for the final blade, the thickness being measured along an axis normal to the thermoplastic strip.

In some embodiments, the at least two layers of the thermoplastic strip are compressed together by a roller and/or are heated.

Heating is carried out, for example, using a laser.

The laser allows the layer of the thermoplastic strip being wound to be heated locally and precisely in order to soften it and fix it to the lower layer.

The roller allows to exert a pressure on the thermoplastic strip so as to fix the thermoplastic strip being wound onto the lower layer.

This way the layers of thermoplastic strip are held on top of each other.

In some embodiments, prior to the heating step, the intermediate element is removed from the support.

The support is therefore not heated. Only the intermediate element is heated.

Thus, a first deformation of the intermediate element can be carried out during the heating step.

In some embodiments, during the heating step, the first extreme point and the second extreme point of the intermediate element are spaced apart from each other.

In other words, during the heating step, a traction is exerted on the intermediate element along its elongation axis so as to lengthen it.

In some embodiments, during the heating step, a traction is exerted at the first extreme point and the second extreme point.

The traction is used to maintain the fibers of the strip along the elongation axis of the intermediate element.

In some embodiments, the method further comprises a positioning step, subsequent to the winding step, in which at least one insert is positioned in the internal space of the intermediate element.

The insert allows, when mounting the blade on the vehicle suspension, to ensure a connection between said blade and said suspension.

In some embodiments, the at least one insert is positioned prior to the heating step.

Thus, the at least one insert is taken at least partly in the intermediate element during deformation. The positioning of the insert is therefore definitive.

In some embodiments, the at least one insert is metallic or plastic.

In some embodiments, a first insert is positioned at the first extreme point, and a second insert is positioned at the second extreme point of the intermediate element.

In some embodiments, during the placing step the intermediate element is deformed using a deformation device.

The deformation device exerts a pressure on the intermediate element so as to deform it before the thermoforming step. This deformation aims to held an internal structure of the intermediate element, in other words an alignment of the fibers of the strip with the elongation axis of the intermediate element.

The deformation device can come into contact with the intermediate element or exert a remote pressure, such as a vacuum.

Another aspect of the invention concerns a blade for a vehicle suspension obtained by implementing a method according to the invention.

### BRIEF DESCRIPTION OF THE DRAWINGS

The invention will be better understood, thanks to the following description, which relates to several embodiments according to the present invention, given as non-limiting examples and explained with reference to the appended schematic drawings, in which:

FIG. 1 is a schematic representation of an intermediate element according to the invention positioned in an oven;

FIG. 2 is a schematic representation of a heating step according to the invention;

FIG. 3 is a schematic representation of a placing step according to the invention;

FIG. 4 is a schematic representation of the placing step according to the invention;

FIG. 5 is a schematic representation of the placing step according to the invention;

FIG. 6 is a schematic representation of the placing step according to the invention;

FIG. 7 is a schematic representation of the placing step according to the invention;

FIG. 8 is a schematic representation of a thermoforming step according to the invention;

FIG. 9 is a schematic representation of the thermoforming step according to the invention.

### DESCRIPTION OF THE EMBODIMENTS

Only the elements necessary for understanding the invention have been shown. To facilitate reading of the drawings, the same elements bear the same references from one figure to another.

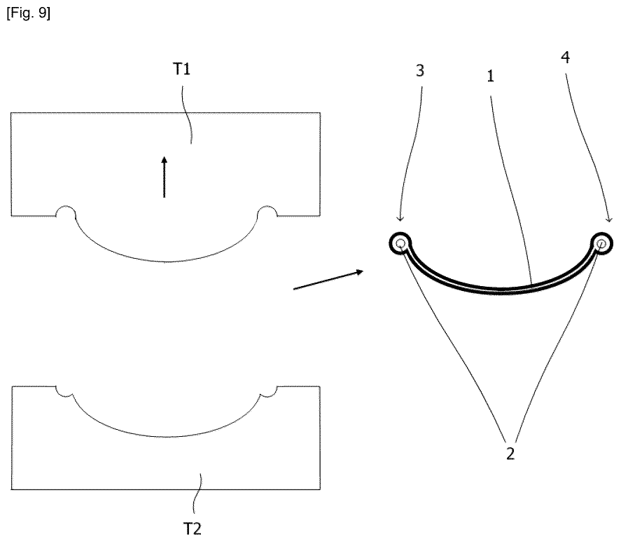

The invention relates to a method for manufacturing a blade 1 for a vehicle suspension and a blade 1 obtained by such a method as illustrated in FIG. 9.

The blade 1 extends along an elongation axis between a first end 3 and a second end 4. The blade 1 is formed by a single-piece element which has a bending rigidity, that is to say when the ends 3, 4 of the blade 1 are stretched, much lower than its tensile rigidity, that is to say along its elongation axis.

The blade 1 according to the invention is configured to be assembled in a vehicle suspension, for example a cycle. For this, the blade 1 comprises at least one first fixing point positioned at the first end 3 and one second fixing point positioned at the second end 4. In the embodiment illustrated in the figures, each fixing point is provided with an insert 2.

The blade 1 is made of a thermoplastic material, that is to say a material having a property of softening when heated but which, when cooling, becomes hard again while retaining a shape obtained when it was hot. The thermoplastic material is recyclable.

In some embodiments, the thermoplastic material is a polymer.

In a resting state, the blade 1 has a curved profile along the elongation axis, the radius of curvature of which can be constant as illustrated in FIG. 9, variable along the elongation axis, multiple, that is to say the blade has an undulating shape, or have secondary profiles, that is to say small undulations which draw a larger undulation.

The blade 1 is elastically deformable between the rest state and an extension state in which the first 3 and second 4 ends are spaced apart from each other relative to the rest state. Thus, during compression of the suspension, the blade 1 is stressed in stretching between two points of the suspension which are fastened to the two fastening points of the blade 1, the two points of the suspension moving away from each other.

The method according to the invention notably comprises a winding step in which an intermediate element 10 is produced.

The intermediate element 10 extends along an elongation axis which will correspond to the elongation axis of the final blade 1.

The intermediate element 10 has a closed contour which delimits at least one interior space 11. In the figures, the intermediate element has a single interior space 11.

In some embodiments, the intermediate element 10 has a convex shape following a section in a plane in which the elongation axis of the intermediate element 10 extends.

The intermediate element 10 comprises a first extreme point 13 and a second extreme point 14 positioned at each of the ends of the intermediate element 10 taken along its elongation axis.

The intermediate element is obtained by winding a thermoplastic strip continuously in an elongation direction of the strip around a support. The support has a shape identical to a shape of the intermediate element 10 obtained by the winding.

In some embodiments, the intermediate element 10 extends along an elongation axis corresponding to a winding direction of the strip, that is to say the elongation direction of the strip.

In some embodiments, the thermoplastic strip comprises fibers extending in the elongation direction of the strip. Preferably, the fibers are continuous fibers.

The strip is therefore a composite thermoplastic strip. The fibers can be carbon or glass fibers.

The fibers extend in the elongation direction of the strip so that, when the strip is wound onto the support, the fibers are not interrupted. Thus, the method retains the mechanical strength properties of the fibers.

The fibers therefore also extend along the elongation axis of the intermediate element 10 and finally along the elongation axis of the blade 1.

In some embodiments, during the winding step, the thermoplastic strip is wound on itself in at least two layers and preferably in a plurality of layers, for example between 5 and 50 layers.

Thus it is possible to obtain a desired thickness for the final blade 1, the thickness being measured along an axis normal to the thermoplastic strip.

In some embodiments, the at least two layers of the thermoplastic strip are compressed together by a roller and/or are heated.

Heating is carried out, for example, using a laser.

The laser allows the layer of the thermoplastic strip being wound to be heated locally and precisely so as to soften it and fasten it to the lower layer.

The roller makes it possible to exert a pressure on the thermoplastic strip so as to fasten the thermoplastic strip being wound to the lower layer.

Thus the layers of thermoplastic strip are held on top of each other.

Next, the intermediate element 10 is removed from the support.

Then, the method comprises a positioning step in which the at least one insert 2 is positioned in the interior space 11 of the intermediate element 10. More precisely, a first insert 2 is positioned at the first extreme point 13, and a second insert 2 is positioned at the second extreme point 14 of the intermediate element 10.

In some embodiments, the at least one insert 2 is metallic or plastic.

The inserts 2 allow, when mounting the blade on the suspension of the vehicle, to ensure a connection between said blade and said suspension. The inserts serve as fastening points of the blade.

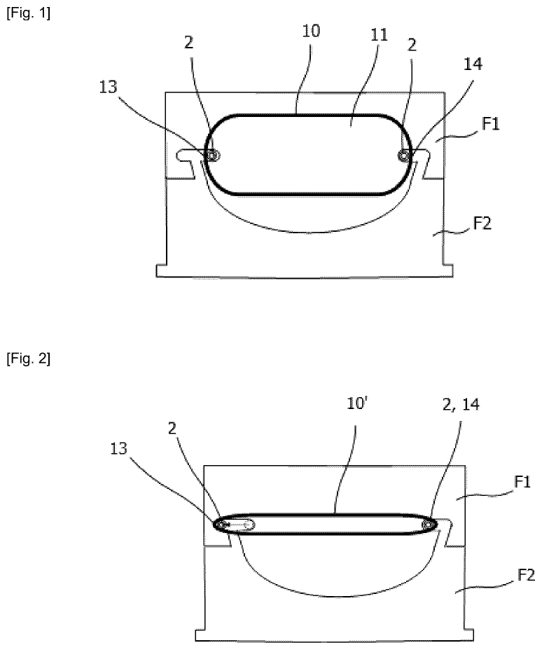

The method according to the invention then comprises a heating step in which the intermediate element 10 is positioned then heated in a heating device, such as an oven or a heating tunnel, as illustrated in FIG. 1.

In the heating device, the intermediate element 10 is positioned on a support which comprises an upper element F1 movable relative to a lower element F2. During operation of the oven, the upper element F1 is positioned on the lower element F2.

The intermediate element 10 is positioned in the upper element F1. More precisely, the intermediate element 10 is held in the upper element F1 by holding elongations inserted in the inserts 2.

During the heating step, the intermediate element 10 is softened so that it can be deformed. More precisely, and as illustrated in FIG. 2, the first extreme point 13 and the second extreme point 14 of the intermediate element 10 are distant from each other. In other words, during the heating step, a traction is exerted by the holding elongations on the intermediate element 10 along its elongation axis so as to lengthen it.

The heated intermediate element 10′ is therefore deformed by holding elongation relative to the intermediate element 10. The inserts 2 are therefore taken at least partly in the heated intermediate element 10′. The positioning of the inserts is therefore definitive.

The traction allows the fibers of the thermoplastic strip to be held along the elongation axis of the heated intermediate element 10′.

Then, the method comprises a placement step in which the heated intermediate element 10′ is placed in a first part T2 of a shaping mold T1, T2.

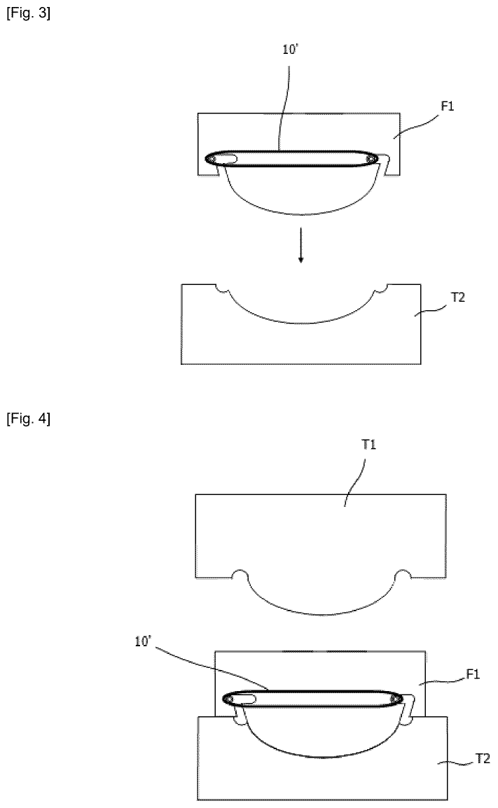

To achieve this, the upper element F1 of the support is separated from the lower element F2, then it is positioned on the first part T2 of the shaping mold T1, T2 as illustrated in FIGS. 3 and 4.

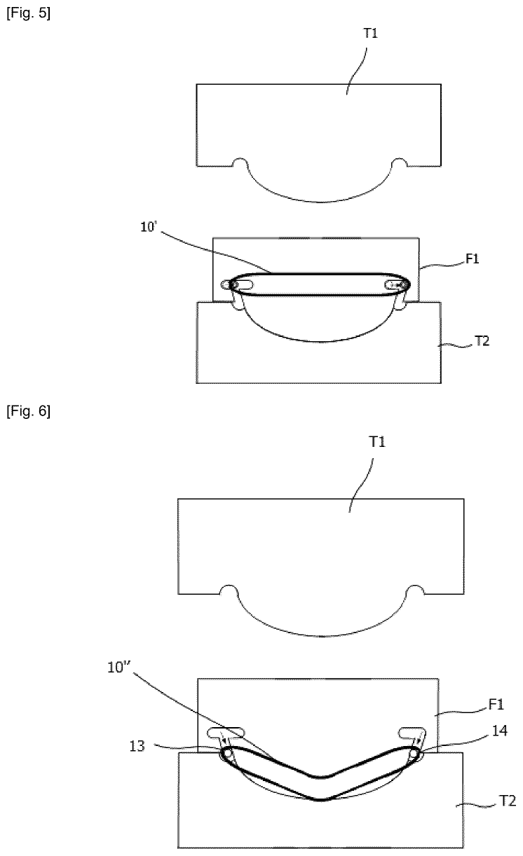

Then, the heated intermediate element 10′ is translated along its elongation axis, as illustrated in FIG. 5. The heated intermediate element 10′ therefore always has the same shape, a length between the inserts 2 has not been modified. This translation makes it possible to modify a position of the holding elongations relative to the upper element F1 so that they may be brought closer to each other subsequently.

Then, the holding elongations, still inserted in the inserts 2, are brought closer to each other and moved towards the first part T2 of the shaping mold T1, T2, as illustrated in FIG. 6. During this displacement, illustrated in FIG. 6, the heated intermediate element 10′ is deformed into a deformed intermediate element 10″.

After this displacement, the deformed intermediate element 10″ is in contact with the first part T2 of the shaping mold T1, T2.

The first extreme point 13 and the second extreme point 14 of the deformed intermediate element 10″ are spaced apart from each other by a distance equal to that separating the first 3 and second 4 ends of the blade 1 in the rest state.

The deformed intermediate element 10″ has a deformation angle positioned substantially in the middle of the deformed intermediate element 10″.

In some embodiments, the heated intermediate element 10′ is deformed by means of a deformation device which exerts a pressure on the heated intermediate element 10′. This deformation has the objective of holding an internal structure of the heated intermediate element 10′, in other words an alignment of the fibers of the thermoplastic strip with the elongation axis of the intermediate element 10.

The deformation device can come into contact with the heated intermediate element 10′ or exert a remote pressure such as a vacuum.

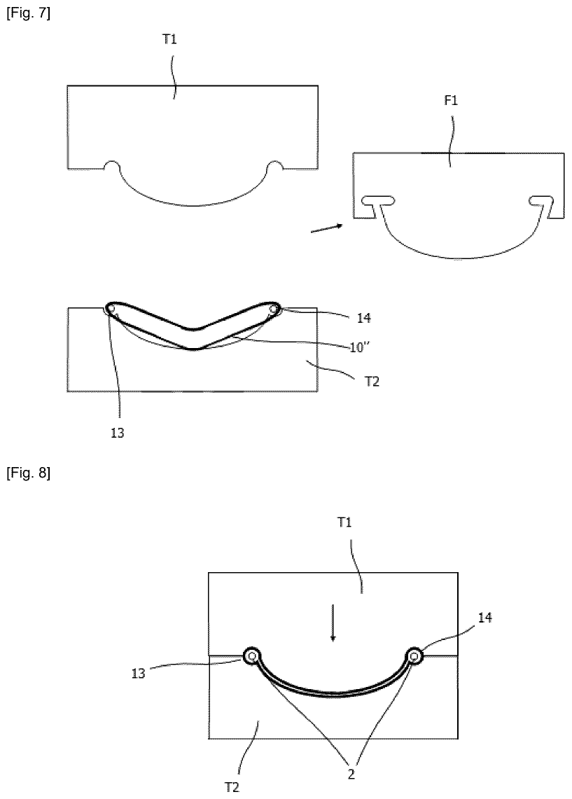

When the deformed intermediate element 10″ is in contact with the first part T2 of the shaping mold T1, T2, the upper element F1 of the support can be removed as illustrated in FIG. 7.

The method then comprises a thermoforming step, illustrated in FIGS. 8 and 9, in which a second part T1 of the shaping mold T1, T2 is closed on the first part T2 and therefore on the deformed intermediate element 10″, so as to obtain the desired blade 1.

During the thermoforming step, the first extreme point 13 and the second extreme point 14 of the deformed intermediate element 10″ are fastened relative to the first part T2 of the shaping mold T1, T2.

When the thermoforming step is completed, the shaping mold T1, T2 is opened and the blade 1 is extracted.

The manufacturing method therefore allows for a high production volume of recyclable blades at low cost.

Although the present invention has been described with reference to specific embodiments, it is obvious that modifications and changes may be made to these examples without departing from the general scope of the invention as defined by the claims. In particular, individual characteristics of the various illustrated/mentioned embodiments may be combined in additional embodiments. Therefore, the description and drawings are to be considered in an illustrative rather than restrictive sense.

It is also obvious that all the characteristics described with reference to a method are transposable, alone or in combination, to a device, and conversely, all the characteristics described with reference to a device are transposable, alone or in combination, to a method.

1. A method for manufacturing a blade for a vehicle suspension, the blade extending along an elongation axis between a first end and a second end, the blade being elastically deformable between a rest state in which the blade has a curved profile along the elongation axis, and an extension state in which the first and second ends are spaced apart from each other relative to the rest state, the blade being made of a thermoplastic material, the method implementing:
a winding step in which an intermediate element is produced by continuously winding a thermoplastic strip around a support such that the intermediate element has a closed contour delimiting at least one interior space, the strip being wound in an elongation direction of the strip;
a heating step in which the intermediate element is positioned and then heated in a heating device;
a placement step in which the heated intermediate element is placed in a first part of a shaping mold such that a first end point and a second end point of the intermediate element, taken along an elongation axis of the intermediate element, are spaced apart from each other by a distance equal to that separating the first and second ends of the blade in the rest state;
a thermoforming step in which a second part of the shaping mold is closed on the first part so as to obtain the blade.

2. The method according to claim 1, wherein the thermoplastic strip comprises fibers extending in the elongation direction of the strip.

3. The method according to claim 1, wherein, during the winding step, the thermoplastic strip is wound on itself in at least two layers.

4. The method according to claim 3, wherein the at least two layers of the thermoplastic strip are compressed onto each other by a roller and/or are heated.

5. The method according to claim 1, wherein, before the heating step, the intermediate element is removed from the support.

6. The method according to claim 1, wherein, during the heating step, the first extreme point and the second extreme point of the intermediate element are spaced apart from each other.

7. The method according to claim 1, further comprising a positioning step, subsequent to the winding step, in which at least one insert is positioned in the interior space of the intermediate element.

8. The method according to claim 7, wherein a first insert is positioned at the first extreme point, and a second insert is positioned at the second extreme point of the intermediate element.

9. The method according to claim 1, wherein, during the placement step, the intermediate element is deformed by means of a deformation device.

10. A blade for a vehicle suspension obtained by implementing a method according to claim 1.
